(19) United States
(12) Patent Application Publication
(10) Pub. No.: US 2015/0113940 A1
(43) Pub. Date: Apr. 30, 2015

(54) SYSTEMS, METHODS, AND DEVICES FOR LIQUID AIR ENERGY STORAGE IN CONJUNCTION WITH POWER GENERATING CYCLES

(71) Applicant: MADA ENERGIE LTD, Jerusalem (IL)

(72) Inventors: STANISLAV SINATOV, KIRYAT-ONO (IL); LEON AFREMOV, TEL AVIV (IL); ARNOLD J. GOLDMAN, JERUSALEM (IL)

(21) Appl. No.: 14/524,815

(22) Filed: Oct. 27, 2014

Related U.S. Application Data
(60) Provisional application No. 61/895,681, filed on Oct. 25, 2013.
(60) Provisional application No. 61/895,712, filed on Oct. 25, 2013.

(51) Int. Cl. F01K 23/12; F01K 23/10; F25J 1/00; F01K 9/02; F01K 15/00; F02C 6/16; F01K 25/08

(52) U.S. Cl. CPC F01K 23/12; F02C 6/16; F01K 23/10; F01K 25/08; F01K 9/02; F01K 15/00; F25J 1/0012; F05D 2260/42; F05D 2220/72; F05D 2220/32
USPC 60/39.182; 60/659

(57) ABSTRACT

Systems, methods, and devices are provided for liquid air energy storage in conjunction with power generating cycles. A system can comprise a power generation apparatus and an energy storage apparatus. The energy storage apparatus can comprise a thermal energy storage unit, and the power generation apparatus and energy storage apparatus can be interconnected via the thermal energy storage unit enabling energy transfer from a first cycle of one of the power generation apparatus and energy storage apparatus to a second cycle of the other apparatus.

### FIELD

The present invention is in the field of energy, and more specifically in the field of enabling non flexible electrical energy generation facilities, such as but not limited to a coal or natural gas based energy power plant, that commonly suffers from a lack of flexibility (i.e. it has limitations of drastic cycling down and/or ceasing its electrical output to the electrical grid) in order to operate with flexibility.

### BACKGROUND

Flexibility in the electrical energy field is becoming more desirable. There may be many reasons for this growing need for flexible and/or dispatchable facilities, including, for example, the increasing introduction of more renewable energy to some electrical grid regions. Some renewable energy sources that are being introduced into the electrical grid can be characterized as being unstable, which is a problem known to one who is skilled in the art. Unstable renewable energy sources may provide large electrical energy power at one point in time and may provide small or no electrical energy power at a different point in time. This may be easily understood by example of solar energy whereas the sun is shining for only part of the day. One who is skilled in the art will know that similar issues can arise with wind power, etc. As discussed above, the introduction of renewable energy may be one of many reasons for the need of flexible electrical energy facilities. Other reasons may be in play in conjunction or as standalone to the already existing or new renewable energy sources being introduced to the electrical grid. The stability of electrical grids may shift from one electrical grid region to another, which may cause some electrical grid regions to need or desire flexible energy facilities more or less than other electrical grid regions.

An unstable electrical grid (i.e. an electrical grid that may suffer from electrical power shifts from one point of time to another) may find flexible and highly dispatchable electrical energy generation facilities as useful and desirable. Some electrical energy generation facilities may be more flexible than others. As known to one who is skilled in the art, a coal power plant may suffer from flexibility issues such as cycling down the electrical output of the plant. It may be the case that a coal plant may cycle down some percentage of the electrical power output of the plant, however as the percentage of the output that is desired to be cycled down (or stopped all together) grows it may become more problematic to do so in a coal power plant. This may be in contrast to simple cycle gas turbine, that may be more flexible and may ramp up and ramp down in shorter intervals with much less difficulties than a coal plant.

As known to one who is skilled in the art, a simple cycle gas turbine may ramp up and ramp down in considerably short periods of time. During periods of time that the electrical grid does not need or desire any additional electrical energy capacity from a Simple Cycle facility, the facility may cease its operation, and cease to dispatch electrical energy output to the electrical grid.

A simple cycle gas turbine may operate in such a way that high temperature exhaust leaving the gas turbine will be released to the environment. As known to one who is skilled in the art, this exhaust gas may be captured and directed to a waste heat steam generator that may generate steam to be utilized to drive a steam turbine. Systems of such nature (i.e. combined cycle gas turbine power plants) can be more efficient. However by capturing and utilizing the exhaust gas, the apparatus may be less flexible (i.e. the ramp up and ramp time may increase). It may be the case that in some regions or electrical grid regions (or for some period of time during the day) there is a desire for flexible faculties. This need or desire may influence the decision in favor for the more flexible and less efficient simple cycle gas turbine, versus the more efficient and less flexible combined cycle gas turbine. In such a case exhaust from the simple cycle gas turbine may not be captured and directed to drive a bottoming steam cycle, but released to the atmosphere at high temperature.

### SUMMARY

Some embodiments of the disclosed matter include a facility that combines a base load energy plant such as a coal or natural gas plant with a Liquid Air Energy Storage (LAES) system (or apparatus) (or facility). Both the base load plant and the LAES may work in conjunction, thus, as will be detailed below, enabling the base load plant to operate in a flexible manner and enabling the facility to be dispatchable when needed and desired. It may be the case that the facility may operate in conjunction with other base load plants (or any other generator of electrical energy).

Some embodiments of the disclosed matter include a system (or apparatus) (or facility) which combines two electrical energy production and/or storage apparatuses, such as, for example, a coal power plant and a LAES.

The LAES may be connected to the coal plant may be charged during one period of time and may be discharged during a second period of time. During the charging period it may be the case that the LAES may convert electrical energy to thermal energy, and store the thermal energy for later use. During the discharge cycle the LAES may convert the thermal energy stored in the LAES to electrical energy.

Thermal energy stored in the LAES may have a range of temperatures. It may be the case that the LAES may convert electrical energy to thermal energy at a range of high temperatures and range of low temperatures. Different ranges of temperatures may be stored in suitable substances for a short or prolonged period of time. In some embodiments, when the LAES is operating in charging mode (charging cycle), it generates liquid air and stores liquid air that has been generated. Generating liquid air may be achieved by assembling devices, apparatuses, etc., such as, for example, compressors. In some embodiments, during periods of time during the charging cycle of the LAES, the LAES may draw down electrical energy (from any electrical energy source) and power one or more compressors. The compressor may trap and compress air from the environment into the LAES. The compressed air may receive an increase in pressure and temperature. The high temperature of the air may be extracted and stored in a high temperature (or relatively high temperature) thermal energy storage unit, compressing the air and extracting the high temperature thermal energy from the air which may be done once or more. The now compressed and cooled down air (air stream) may be further processed in order to achieve liquefaction. Further processing of the air may involve directing the air through a one or more heat exchangers in order to further reduce the temperature of the air stream. The air stream, or part of it may be processed through apparatuses such as, for example, refrigeration apparatuses (or any other apparatus resulting in a reduction of the air streams temperature). The air stream may be directed through a device such as an expander, a throttling device, and/or other means or apparatuses that may reduce the pressure and temperature of the air stream. In some embodiments, the air stream at the outlet of the expander or throttle device may be liquefied. In some such embodiments, a portion of the air stream may be liquefied and the rest of the air stream may remain in a gaseous form. The air which remained in a gaseous form may be directed through one or more heat exchangers, exchanging thermal energy with the air stream compressed through the LAES (i.e. after the compression stage and prior to the expansion stage), thus reducing the air stream temperature. The air stream which has transformed to liquid may be stored in a liquid air storage unit. In some embodiments, at the end of the charging process, the LAES may contain liquid air in a liquid air storage unit and high temperature (or relatively high temperature) thermal energy may be stored in high temperature thermal energy storage units.

According to some embodiments, high temperature from the air stream may not be utilized in the LAES. In such embodiments, there may be no high temperature thermal energy stored in the high temperature storage units (associated with the storage of heat which may be captured during the air compression).

In some embodiments, a LAES may operate at a second period of time in discharge mode. In such a mode of operation, a pump may direct liquid air from the liquid air storage through the different thermal energy storages of the LAES (or other thermal energy storages or thermal energy sources and/or locations). During this process the liquid air may exchange high thermal energy that is stored in the storage units (or receive high thermal energy from different sources and/or locations) and emit low thermal energy to the storage units that may be stored for later use (e.g., during the charging cycle as means to reduce the temperature of the air stream). The liquid air which has been pumped at desired pressures, and received high temperature thermal energy may be directed to drive one or more turbines which may generate electrical energy.

Some embodiments comprise two (or more) facilities/systems wherein one facility/system may be a coal power plant. The coal power plant may operate in a few modes of operation. One of these modes of operation may result in the electrical output of the coal power plant being dispatched onto the electrical grid.

A second mode or operation may result in having no (or limited) electrical output of the coal power plant dispatched on to the electrical grid. During a first period of time when there is a need for the coal plant's power output to be directed to the electrical grid, the coal power plant may combust coal and generate steam that may be directed to drive a steam turbine. Driving the turbine may generate electrical energy that may be dispatched on to the electrical grid. During a second period of time when there is no need for electrical power output (or a need for a limited power from the coal plant) the LAES may draw down energy from the coal plant. In some embodiments, the LAES may draw down power from the coal plant in a few methods, where the end result of one or more of such methods may be a total or limited reduction of power that is generated and dispatched from the coal plant to the electrical grid. For example, in some embodiments, the LAES draws down electrical energy from the coal plant's output power outlet, and the LAES converts such electrical energy to thermal energy that may be stored in the LAES for later use according to any of the methods described herein, thus achieving a state where no or limited power is dispatched from the coal plant to the electrical grid.

At a third period of time when power is once again needed or desired, the LAES may operate in a discharge mode of operation as stated above, resulting in the conversion of the thermal energy stored in the LAES to electrical energy which may be dispatched the electrical grid (or any other consumer). Dispatching power from the LAES may occur during and/or separated from the time when the coal power plant is dispatching power to the electrical grid.

In some embodiments, energy can be drawn down from the coal plant to the LAES in the form of high temperature steam. A percentage (which may be a high percentage, low percentage, all or none) of the high temperature steam (stream) produced by the coal power plant may be directed to a thermal energy storage unit which may be associated to the LAES. The stream of high temperature steam may enter such a storage unit, and may charge a suitable substance within the thermal energy storage unit with high temperature thermal energy. During the process of charging the substance within the thermal energy storage unit to high temperature, the stream's high temperature may be extracted from the steam, which may result in a reduction of the stream's temperature and may transform the steam back in to a liquid which may be recycled back to the coal plant's steam cycle. The remaining portion of the steam (in the event that not all of the steam was diverted to charge the thermal energy storage unit) may be directed to drive the steam turbine of the coal plant. The result of such operations may be a reduction in and/or an elimination of power from being dispatched to the electrical grid from the coal plant. During the discharge cycle of the LAES, the liquid air may be pumped through one or more different high temperature thermal energy storage units. The pumped liquid or evaporated air may enter the thermal storage unit and exchange thermal energy with the substance located within the storage unit, receiving high temperature thermal energy contained within the substance and exchanging low temperature thermal energy to the substance located within the storage unit. The pumped liquid air vapor may be directed to drive a turbine which may generate electrical energy that may be dispatched on to the electrical grid.

In some embodiments, a coal power plant includes multiple generation units. The coal plant may operate as a base load plant. In some specific regions there may be no need for the coal plant to operate as a base load and in such regions there instead may be a need or desire for the coal plant to operate as a backup plant (i.e. dispatching power for only a number of hours per day). In some embodiments, the coal plant may operate a portion of the generation units at (or near) full power constantly and idle a portion of the generators constantly. During a first period of time when power is not needed from the coal plant, the LAES may draw down energy from the coal plant. Energy may be in the form of electrical and/or thermal energy. Electrical energy may be drawn down from the coal plant's electrical output to power the LAES's compressor as described herein. Thermal energy may be drawn down by directing a stream of steam that was generated by the coal plant to charge the thermal energy storage unit as described herein. It may be the case that a portion of the generated energy will be drawn down by the LAES or all of the said generated energy will be drawn down. In some embodiments, during a second period in which power is needed on the grid, power will be dispatched from the coal plant. Power may be dispatched from the coal plant and the LAES in conjunction. The configuration and sizing of the LAES may be a function of power and the duration of the needed power. The power generating units that are selected to be idled or operated may be a function of the different priorities of different generators and/or the generators may operate in a rotation.

In some embodiments, a facility combines the LAES with the coal power plant, and the facility may operate to reduce electrical energy supplied to the electrical grid during periods of time when the electrical grid may contain a higher than desired electrical power. In some embodiments, combining LAES with the coal plant enables the coal plant to continuously operate at full (or close to full) load, which may result in less wear and tear to the coal plant due to limited (or non) partial load operations.

In some embodiments, a facility is disclosed containing two (or more) facilities, whereas one facility (or apparatus) may be a simple cycle gas turbine. The second facility (or apparatus) may be LAES, whereas the exhaust gas exhausted by the gas turbine may be directed to a thermal energy storage unit. It may be the case that the exhaust gas may exchange thermal energy with a suitable substance within the thermal energy storage unit, prior being vented from the facility. It may be the case that the exhaust gas high temperature may be stored within the said substance for a short or prolonged period of time and it may be the case that the said high thermal energy temperature will be utilized at a later period of time (this process may be referred to as charging of the said thermal storage unit). By one embodiment of the disclosed matter, LAES may generate electrical energy by pumping liquid air (generated and stored in the LAES during the charging cycle) through one or more thermal energy storage units. The pumped air may exchange low temperature thermal energy with high temperature thermal energy of the thermal storage unit. It may be the case that the liquid air at the outlet of the thermal storage unit may have high temperature and pressure needed for the expansion at the turbine (or turbine units) and the generation of electrical energy. It may be the case that the liquid air may be directed to the said high temperature thermal energy storage that has been charged by the exhaust gas from the said simple cycle gas turbine. It may be the case that the liquid air may be directed through the said thermal storage unit and may exchange thermal energy with a charged substance located in or associated to the said thermal energy storage unit, thus increasing the temperature of the air stream and reducing the temperature of the said substance (this process may be referred to as discharge of the thermal energy storage). It may be the case that the turbine may operate at higher efficiencies as a result of the higher temperature differences between the temperature of the liquid air and the temperature of the air stream entering the inlet of the turbine. It may further be the case that by passing the air stream through the said thermal energy storage which has been charged via the exhaust from the simple cycle gas turbine that an increase in the said temperature difference may be achieved.

In some embodiments, discharge of the LAES may occur during a period of time when the simple cycle's gas turbine is operational, in such a case the total dispatched power may come from both facilities. Additionally or alternatively, discharge of the LAES may occur during a period of time when the simple cycle's gas turbine is not operational. Additionally or alternatively, the simple cycle′ gas turbine may be operational and the simple cycle's exhaust gas may charge the LAES during a period of time when the LAES's discharge cycle is not operational.

In some embodiments, the simple cycle gas turbine may operate to generate electrical energy to the electrical grid (or any other electrical consumer). During the period of time when the simple cycle's gas turbine is operational, the exhaust gas may be directed to charge the high temperature thermal storage. The LAES may operate to generate and dispatch electrical energy to the electrical grid (or any other electrical consumer). During the period of time when the LAES is in such an operational mode, the liquid air may be directed to discharge the high temperature thermal storage. Both the simple cycle gas turbine and the LAES can be configured to generate electrical energy during the same or overlapping periods of time (in such a case the high temperature thermal energy storage may simultaneously charge and discharge). In some configurations, one unit may operate to generate electrical energy without the other (i.e. only the simple cycle or only the LAES) and it may be the case that neither will generate electrical energy.

In some embodiments, LAES may be charged by drawing down electrical energy from the electrical grid or any other electrical source. By one embodiment the simple cycle may operate to generate electrical energy (and charge the said high temperature thermal storage unit) but not dispatch the electrical energy to the electrical grid. In such mode of operation the electrical output of the simple cycle's gas turbines may be draw down and consumed by the LAES and the LAES may operate in a charging mode.

Charging the said high temperature thermal storage unit may be done by any number of simple cycle gas turbines.

### BRIEF DESCRIPTION OF THE DRAWINGS

FIG. 1 illustrates a Liquid Air Energy Storage (LAES) system, in accordance with an embodiment of the present disclosure.

FIG. 2 illustrates a LAES-enabled energy generation system with external heat recovery of heat generated by a high temperature steam generator, in accordance with an embodiment of the present disclosure.

FIG. 3 illustrates a LAES-enabled energy generation system with external heat recovery of heat generated by a high temperature steam generator, in accordance with an embodiment of the present disclosure.

FIG. 4 illustrates a LAES-enabled energy generation system with external heat recovery of heat contained in high temperature exhaust gas, in accordance with an embodiment of the present disclosure.

FIG. 5 is a block diagram of a system 500 for flexible and/or dispatchable energy generation using liquid air energy storage in conjunction with power generating cycles, in accordance with an embodiment of the present disclosure.

### DETAILED DESCRIPTION

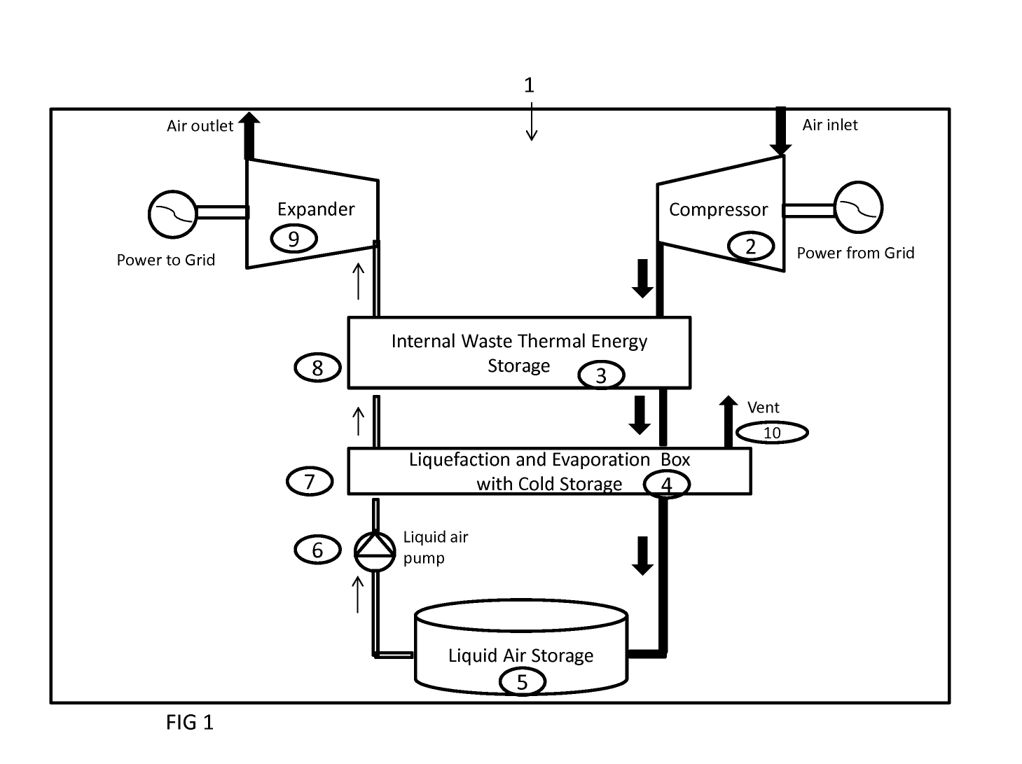

FIG. 1 illustrates a Liquid Air Energy Storage (LAES) apparatus (or “LAES”) 1, in accordance with an embodiment of the present disclosure. LAES 1 may operate in a few modes of operation.

In a first mode of operation, LAES 1 may draw down electrical energy from any electrical source, and convert the electrical energy to both high and low thermal energy temperatures (this mode will be referred to as the charging cycle/mode). In a second mode of operation, which may be performed during the same, different, or overlapping period of time, LAES 1 may convert thermal energy stored in the LAES 1 to electrical energy that may be dispatched to the electrical grid. 4

In operation, LAES apparatus 1 may operate in charging mode. During the charging mode an electrical energy may be drawn down from any electrical energy source to power the compressor 2 (or compressors indicated by compressor 2). The compressor 2 may trap air from the environment into the LAES 1. The compressed air's temperature and pressure may rise as a result of the compression. High thermal energy may be extracted from the air and stored in internal waste thermal energy storage 3. The air stream may be directed for further processing in order to liquefy the air stream. Further liquefaction may be a result of means and apparatuses such as directing the air stream through on or more cold storage units, further refrigeration devices (or apparatuses that resemble or operate as refrigeration), and/or throttle devices, expansion turbines, etc. In some embodiments, the apparatuses such as cold storages units, further refrigeration devices (or apparatuses that resemble or operate as refrigeration), throttle devices, or expansion turbines, etc. may be located or associated to the liquefaction and evaporation box with cold storage 4. In some embodiments, the air stream exiting the liquefaction and evaporation box with cold storage 4 may be liquefied. Liquid air may then be stored in liquid air storage 5. A portion of the air stream may remain in a gaseous form, and such portions of the air stream which have remained in a gaseous form will be directed through the liquefaction and evaporation box with cold storage 4, in order to utilize the cold thermal energy contained in that stream. The air stream that has been redirected through the liquefaction and evaporation box with cold storage 4 may be vented out of the LAES 1 after exchanging thermal energy with the air stream that may be processed for liquefaction.

The LAES apparatus 1 may also operate in a discharge mode. In discharge mode, a liquid air pump 6 pumps liquid air from the liquid air storage unit 5, through the LAES apparatus 1 at a desired pressure. The liquid air may be processed in the liquefaction and evaporation box with cold storage 7 (where the number change is indicative of the two modes of operation: charge 4 and discharge 7). During this process the liquid air stream may exchange thermal energy with the charge mode's air stream which may be cooled down. The pumped air stream exits the liquefaction and evaporation box with cold storage 7 and is directed to the internal waste thermal energy storage 8. In the internal waste thermal energy storage 8, the pumped liquid air stream (now in a gaseous form after evaporation) may further exchange thermal energy with the incoming air. The air stream may exchange relatively low thermal energy temperature (relative to the thermal energy contained in the waste thermal energy storages units) with relatively high thermal energy contained in the substances of the internal waste thermal energy storage 8. Relatively low thermal energy that has been extracted from the liquid air may be stored in the waste thermal energy storage for use during the charging cycle. The air stream exiting the internal waste thermal energy storage 8 may be directed to drive an expander (or “turbine”) 9 (or turbines indicated by turbine 9), which may generate electrical energy.

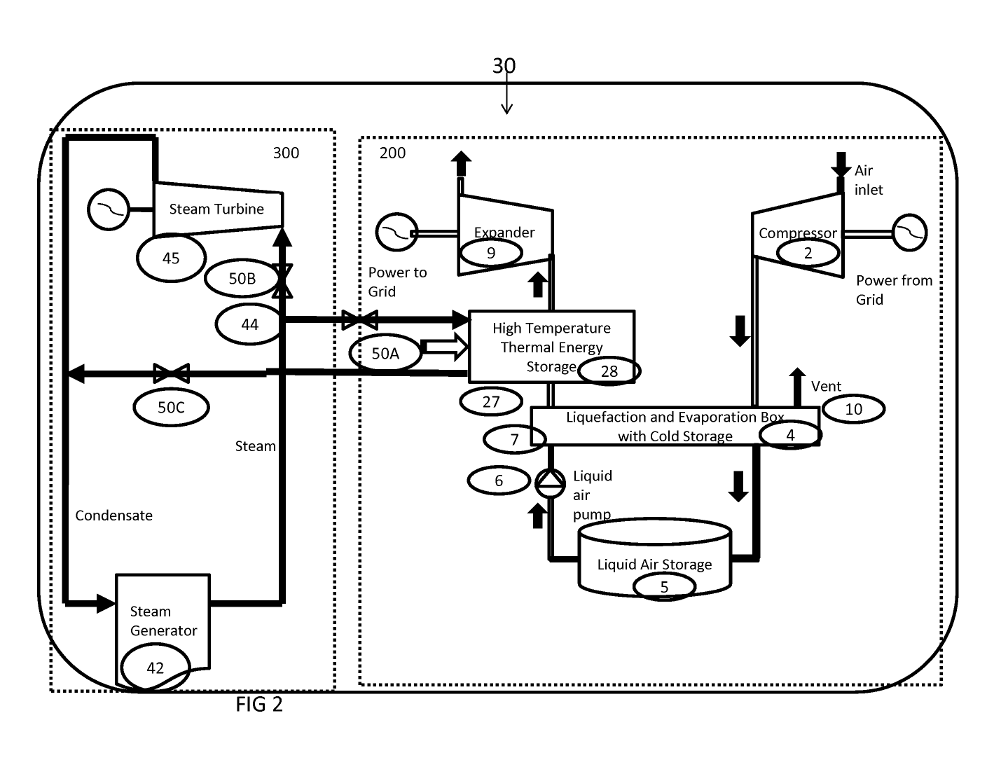

FIG. 2 illustrates a LAES-enabled energy generation system 30 external heat recovery of heat generated by a high temperature steam generator, in accordance with an embodiment of the present disclosure. System 30 includes LAES 200 and block 300. Block 300 includes a steam generator 42 that generates steam which is directed to turbine 45 which generates electrical energy. A portion of the stream (all, some, or none) may be directed to the high temperature thermal energy storage unit 28 (which is indicated in block 200). High temperature heat from the steam may be extracted and stored by a suitable substance in a storage unit (tank or tanks) within the high temperature thermal energy storage unit 28.

In some embodiments, during the process of extracting high temperature thermal energy from the steam and exchanging high temperature thermal energy from the steam with relatively low thermal energy temperature contained in the said storage unit, the steam may be condensed and returned to the steam cycle. Valves 50A, 50B, and 50C arer controlling valves (although there may be more additional valves or less valves than indicated). Steam exhausted from the turbine 45 is condensed and recycled back to the steam generator 42. A portion of the steam generated in the steam generator 42 is directed to the turbine 45 and another portion will be directed to the high temperature thermal energy storage unit 28. Steam division can be controlled in junction 44 by valves 50A, 50B, and/or 50C. All of the steam can be directed to one direction only or split into two (equal or non-equal) streams and distributed accordingly.

LAES apparatus 200 can be operated in conjunction with the process described above with respect to block 300. LAES 200 may operate in a few modes of operation, such as, for example, one or more of the modes of operation described above with respect to LAES 1 shown in FIG. 1. For example, LAES 200 may convert electrical energy to thermal energy by compressing air from the environment in to the LAES 200, processing the air stream, cooling the air stream and finally liquefying the air stream (as described above).

In some embodiments, the internal waste heat from the compression process will not be stored as discussed above with respect to FIG. 1, and instead the high temperature thermal energy from the compression of the air is dissipated to the environment. In other embodiments, the internal waste heat from the compression process is stored as indicated above. In some such embodiments, LAES 200 includes an internal waste thermal energy storage such as, for example, internal waste thermal energy storage 3/8 shown in FIG. 1.

During the discharge cycle, liquid air may be pumped from the liquid air storage 5 by a liquid air pump 6. The liquid air may exchange thermal energy with the substance located within the cold thermal storage units of the liquefaction and evaporation box with cold storage 7 as detailed above. The air stream is directed to the high temperature thermal energy storage unit 28 to exchange thermal energy with the substances located in the storage units of the high temperature thermal energy storage unit 28. The air stream is then directed to drive expander (or “turbine”) 9 (e.g., one or more turbine units) to generate electrical energy.

In some embodiments, all, some, or none of the electrical output of turbine 45 can be configured to be directed to power compressor 2 such that system 30 may not output electrical energy to the electrical grid or may output electrical energy lower than the electrical energy produced by the turbine (or turbine units).

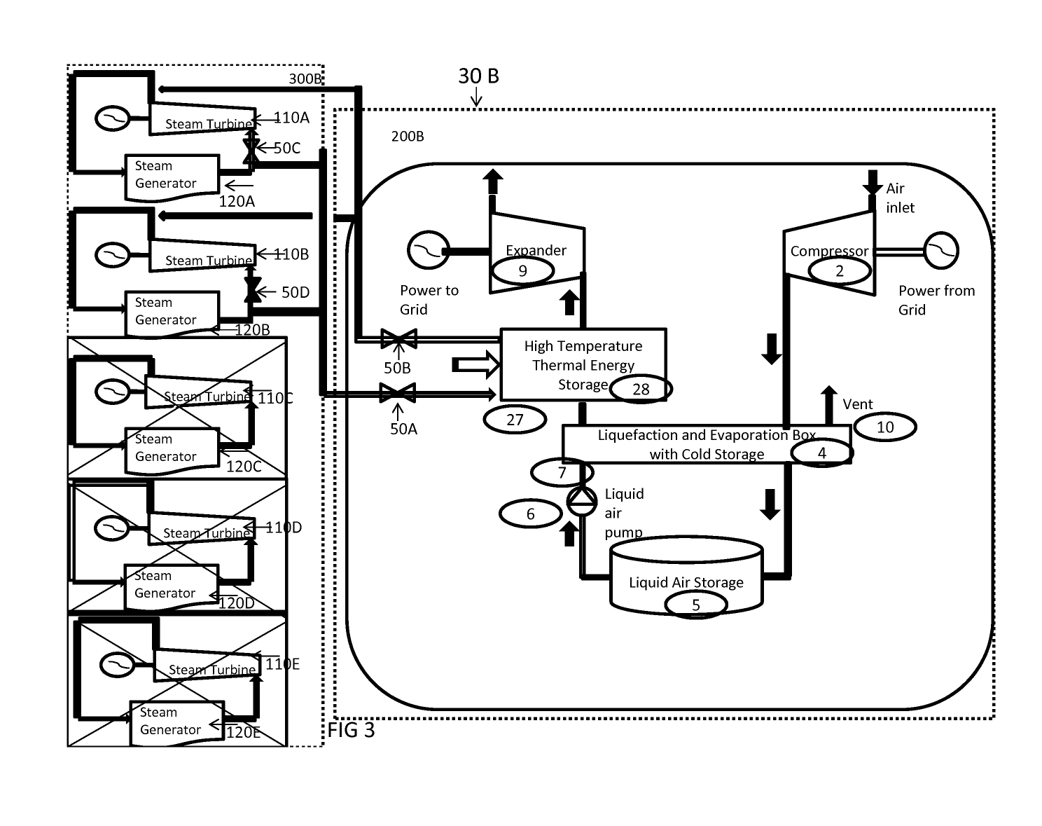

FIG. 3 illustrates a LAES-enabled energy generation system 30B with external heat recovery of heat generated by a high temperature steam generator, in accordance with an embodiment of the present disclosure. System 30B is divided into the two apparatuses, 200B and 300B (e.g., for explanation purposes). System 30B includes LAES 200B and steam generator (or “block”) 300B. Steam generator 300B is comprised of 5 steam generation units of which 3 generation units are idle and 2 are operating at or near full power.

LAES apparatus 200B may operate in one or more modes such as, for example, the modes described above with respect to LAES 1 and 200 shown in FIGS. 1 and 2, respectively. Block 300B may be a coal power plant having five generation units. Each generation unit contains a steam generation device indicated by steam generation devices 120A, 120B, 120C, 120D, 120E, and each generation unit contains a steam turbine indicated by steam turbines 110A, 110B, 110C, 110D, 110E. A portion of the generation units can be idled, and a portion can operate at or near full capacity. For example, FIG. 3 indicates three idled generation units, indicated by a cross on the generation units, and two operational generation units indicated by no cross on the generation units.

System 30B may operate in a flexible manner, whereas the operational power generation units may generate steam 120A, 120B. A portion or all of the steam may be directed to the steam turbines 110A, 110B, and may generate electrical energy. A portion or all of the steam may be directed to charge the high temperature thermal energy storage 27, and the steam flow may be controlled and/or altered by valves indicated by valves 50A, 50B, 50C, 50D (as an example). At one period of time steam can be directed to the steam turbines 110A and 110B, and electrical energy generated by the steam turbines 110A and 110B, may be dispatched to the electrical grid. At a second period of time the electrical energy generated by the steam turbines 110A andl 10B can be drawn down by the LAES's compressor 2, for charging the LAES. Energy stored in the LAES may be converted to electrical energy and dispatched to the electrical grid during periods when electrical energy is generated and dispatched from the coal power plant, thus increasing the power output of the coal plant operating with a limited number of generation units. Dispatching electrical energy from the coal power plant and the LAES can occur at the same, different, or overlapping periods of time.

System 30B may dispatch electrical energy of both the coal power plant and the stored energy within the LAES. During periods of time in which there is no need or desire for the electrical energy from the coal power plant, the electrical energy or thermal energy may be stored in the LAES. Thus, during such periods of time, the coal power plant generation units (non idle) may operate at or near full power. The generation units' efficiency may be affected during periods of time when they are operating at lower than full power, and thus overall efficiency of the generation units can be increased as a result of operating them at or near a constant full capacity load.

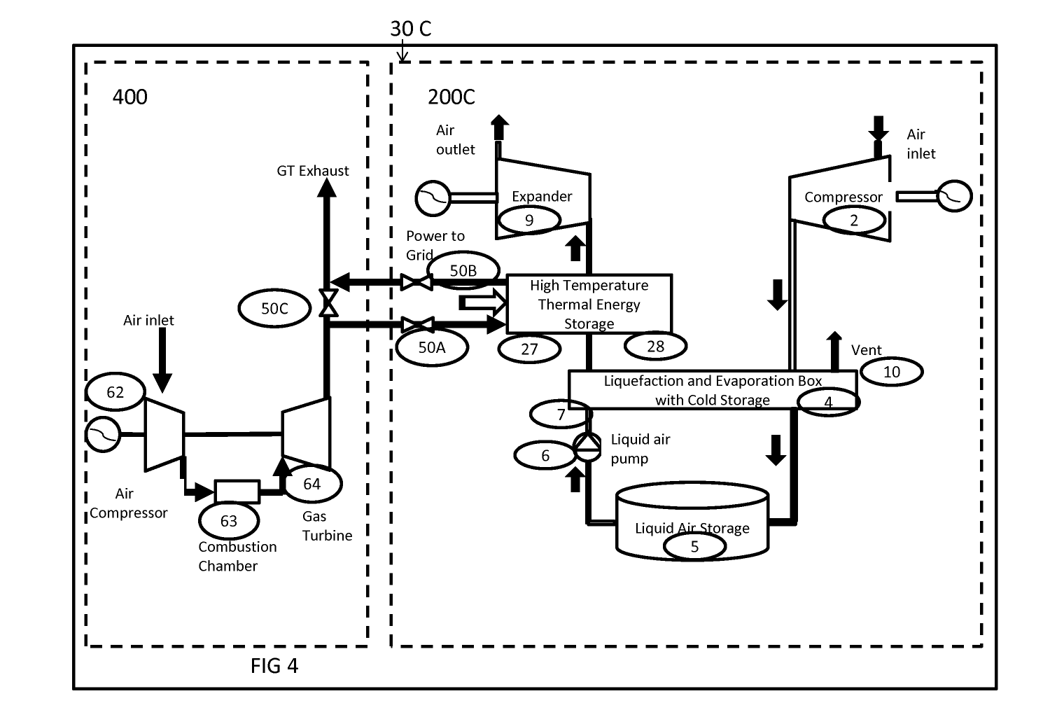

FIG. 4 illustrates a LAES-enabled energy generation system 30C with external heat recovery of heat contained in high temperature exhaust gas, in accordance with an embodiment of the present disclosure. System 30C may be divided into two apparatuses, block 400 and LAES 200C, for explaining purposes. Block 400 shows a simple cycle gas turbine, where air is compressed via an air compressor 62, and is directed to a combustion chamber 63, gas is injected into the combustor thus generating high temperature gas to drive a gas turbine 64. The high temperature exhaust gas may be directed to a high temperature thermal energy storage 27 prior to exiting the system 30C. The exhaust gas may charge a substance in the high temperature thermal energy storage 27, and the substance may store the high temperature from the exhaust gas. Valves can direct the flow of the exhaust gas, such as valves 50A, 50B, 50C.

LAES 200C can be operated in conjunction with the operation described above of block 400. The LAES 200C may operate in few modes of operation such as, for example, the modes discussed above with respect to LAES 1, 200, and 200B shown in FIGS. 1, 2, and 3, respectively. LAES 200C may convert electrical energy to thermal energy by compressing air from the environment into LAES, processing the air stream, cooling the air stream and finally liquefying the air stream (as described above).

In some embodiments, the internal waste heat from the compression process will not be stored as indicated above, and the high temperature thermal energy is released back to the environment. In other embodiments, the internal waste heat from the compression process is stored as indicated above. In some such embodiments, the internal waste heat from the compression process can be stored as described above in an internal waste thermal energy storage such as, for example, internal waste thermal energy storage 3/8 shown in FIG. 1. During the discharge cycle, liquid air may be pumped from the liquid air storage 5 by a liquid air pump 6. The liquid air may exchange thermal energy with the substance located within the cold thermal storage units of the liquefaction and evaporation box with cold storage 7 as detailed above. The air stream may be directed to the high temperature thermal energy storage unit 28, and exchange thermal energy with the substances located at the storage units of the high temperature thermal energy storage unit 28. The air stream will then be directed to drive a turbine 9 to generate electrical energy.

In some embodiments, the electrical output of the turbine 64 may be directed to power the compressor 2 in LAES 200C such that system 30C may not output electrical energy to the electrical grid or may output electrical energy lower than the electrical energy produced by the turbine 64 (or turbine units).

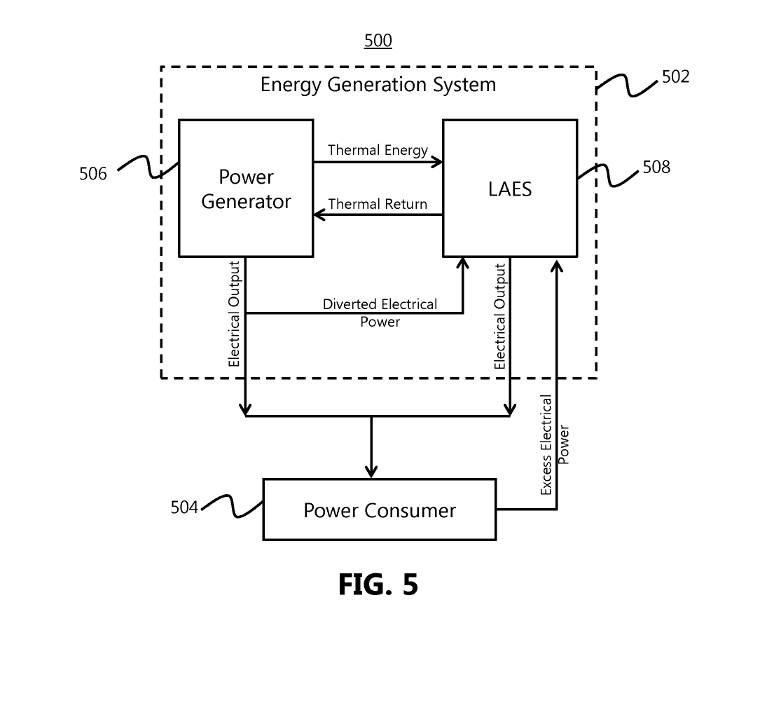

FIG. 5 is a block diagram of a system 500 for flexible and/or dispatchable energy generation using liquid air energy storage in conjunction with power generating cycles, in accordance with an embodiment of the present disclosure. System 500 includes an energy generation system 502 and a power consumer 504. The energy generation system 502 includes a power generator 506 and a LAES 508. The power generator 506 and a LAES 508 output electrical power to power consumer 504 (e.g., an electrical grid). The power generator 506 can provide thermal energy (e.g., steam/gas) to LAES 508, and LAES 508 can provide thermal return (e.g., steam/liquid) to power generator 506. System 502 can be configured to divert some or all of the electrical output of power generator 506 to LAES 508, and can be configured to provide some or all of any excess electrical power on power consumer 504 (e.g., excess electricity on the electrical grid) to LAES 508.

In operation, LAES 508 is configured to perform a charging cycle/mode to convert electrical power to stored energy and a discharge cycle/mode to convert stored energy into electrical power to be output to power consumer 504, as described above including, for example, as described with respect to LAES 1, 200, 200B, and 200C shown in FIGS. 1-4, respectively.

In some embodiments, system 502 is configured to divert, when the full electrical output of power generator 506 is not needed or desired by power consumer 504, some or all of the electrical output of the power generator 506 to LAES 508, as described above including, for example, as described with respect to FIGS. 2-4.

It will be appreciated that power generator 506 can be any type of power generator such as a coal power plant generator, steam turbine generator, or gas turbine generator, as discussed above with respect to FIGS. 2-4. For example, in some embodiments, power generator 506 is a coal power plant with one or more steam turbines, and in such embodiments the thermal energy provided by power generator 506 to LAES 508 is steam and the thermal return can include one or both of steam and liquid, such as, for example, discussed above with respect to FIGS. 2 and 3. In some embodiments, power generator 506 is a simple cycle gas turbine, and in such embodiments the thermal energy provided by power generator 506 to LAES 508 is high temperature exhaust gas and the thermal return can include gas, as discussed above including as discussed, for example, with respect to FIG. 4.

It will also be appreciated that power consumer 504 can be any type of power consumer such as, for example, an electrical grid or other power consumer. In some embodiments, power consumer 504 is an electrical grid, and in some such embodiments system 500 is configured to detect excess power on the grid and cause some or all of such excess power to be provided to LAES 508 to be converted and stored as disclosed herein.

Several embodiments are specifically illustrated and/or described herein. However, it will be appreciated that modifications and variations of the disclosed embodiments are covered by the above teachings and within the purview of the appended claims without departing from the spirit and intended scope of the present disclosure.

1. A system comprising:
a power generation apparatus; and
an energy storage apparatus comprising a thermal energy storage unit,
the power generation apparatus and energy storage apparatus being interconnected via the thermal energy storage unit enabling energy transfer from a first cycle of one of the power generation apparatus and energy storage apparatus to a second cycle of the other apparatus.

2. The system of claim 1, wherein the energy storage apparatus is a Liquid Air Energy Storage (LAES) unit, the LAES unit having a plurality of modes of operation, the modes of operation comprising:
a first mode of operation being a charge mode in which the LAES unit generates liquid air;
a second mode of operation being a discharge mode in which the LAES unit generates electricity by heating and evaporating the liquid air and expanding the liquid air through an expander; and
a third mode of operation being an idle mode in which the LAES unit does not generate liquid air and does not generate electricity.

3. The system of claim 1,
wherein the power generation apparatus is a power plant where the power generation is achieved by the generation of steam; and
wherein the generated steam is expanded through a steam turbine.

4. The system of claim 3,
wherein the power plant is interconnected to the energy storage unit with one or more conduits allowing the transfer of the generated steam to the thermal energy storage unit;
wherein the LAES unit is interconnected to the power plant with one or more conduits allowing the transfer of at least one of liquid air or liquid air vapor to the power plant;
wherein the transfer of steam from the power plant is regulated by one or more valves;
wherein the transfer of the at least one of liquid air or liquid air vapor from the LAES unit is regulated by one or more valves.

5. The system of claim 4, wherein the thermal energy storage contains a suitable material for storing thermal energy contained within the thermal energy storage unit.

6. The system of claim 4,
wherein the generated steam can be directed to at least one of the steam turbine or the thermal energy storage unit, and
wherein steam direction and mass flow are controlled by the one or more valves.

7. The system of claim 6, wherein the steam direction and mass flow can be at least one of:
the full mass flow is directed towards the steam turbine;
the full mass flow is directed towards the thermal energy storage unit; or
a first portion of the mass flow is directed towards the steam turbine and a second portion is directed towards the thermal energy storage unit.

8. The system of claim 7, wherein the thermal energy storage unit is charged with high temperature thermal energy during a period of time when the control valves are configured to direct the second portion of the full mass flow of the generated steam to the thermal energy storage unit.

9. The system of claim 7, wherein the power generated by the power plant during a period of time when the control valves are configured to direct the first portion or the full mass flow of the generated steam to the steam turbine is dispatched to one of: the electrical grid, the power inlet of the LAES unit, or a first portion of the generated power to the electrical grid and a second portion of the generated power to the inlet of the LAES unit.

10. The system of claim 4,
wherein the thermal energy storage unit transfers heat to the at least one of liquid air or liquid air vapor stream; and
wherein the liquid air vapor exiting the thermal energy storage unit is directed to be expanded by an expander of the LAES unit.

11. The system of claim 3, further comprising:
when power is dispatched from the system, the system being configured to dispatch power from one or both of the power plant and the LAES unit; and
when no power is dispatched from the system, neither the power plant nor the LAES unit dispatch power and all energy generated from the power plant is drawn down and stored within the LAES unit.

12. The system of claim 1,
wherein the power generation apparatus is a power plant where the power generation is achieved by the combustion of gas and its expansion through a gas turbine;
wherein exhaust gas from the gas turbine contains high temperature thermal energy;
wherein the exhaust gas is directed towards the thermal energy storage unit; and
wherein the high temperature thermal energy is extracted from the exhaust gas and is stored in a suitable material contained within the thermal energy storage unit.

13. The system of claim 12, wherein the thermal energy storage unit is charged with high temperature thermal energy during a period of time when the exhaust gas is directed to the thermal energy storage unit, and discharged from high temperature thermal energy during a period of time when at least one of liquid air or liquid air vapor is directed through the thermal energy storage unit.

14. The system of claim 12, wherein the liquid air vapor is directed to be expanded by an expander of the LAES unit.

15. The system of claim 12,
the system configured to dispatch power from one or both of the power plant and the energy storage apparatus;
the system configured, when no power is dispatched from the power plant or the energy storage apparatus, to cause the power plant to operate in at least one of a plurality of modes of operation, the plurality of modes of operation comprising:
an idle mode of operation;
an operational mode of operation in which power generated by the power plant is directed to a power inlet of the energy storage apparatus.

16. A facility comprising:
a plurality of apparatuses including:
a power generation apparatus, and
an energy storage apparatus;
the energy storage apparatus having a power inlet;
the power generation apparatus being coupled to the power inlet of the energy storage apparatus; and
the power generated by the power generation apparatus being directable to the power inlet of the energy storage apparatus.

17. The facility of claim 16,
wherein the facility is configured to, when dispatching power, dispatch power from one or both of the power generation apparatus and the energy storage apparatus;
wherein the facility is configured to, when not dispatching power, not dispatch power from the power generation apparatus and the energy storage apparatus;
wherein, the power generation apparatus is configured to, when the facility is not dispatching power, operate in at least one of a plurality of modes of operation, the plurality of modes of operation comprising:
an idle mode of operation; and
an operational mode in which at least a portion of power generated by the power generation apparatus is directed to a power inlet of the energy storage apparatus.
